(19) United States
(12) Patent Application Publication
(10) Pub. No.: US 2003/0027585 A1
(43) Pub. Date: Feb. 6, 2003

(54) Communication system and communication method thereof

(75) Inventor: Hiroya Ohnishi, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: FUJIKURA LTD., Tokyo (JP)

(21) Appl. No.: 10/208,849

(22) Filed: Aug. 1, 2002

(30) Foreign Application Priority Data
Aug. 6, 2001 (JP) 2001-238240

(51) Int. Cl. H04B 7/005

(52) U.S. Cl. 455/503; 455/506; 455/504

(57) ABSTRACT

The communication system executes one-to-multi peer communications between a master station (A) and many salve stations (B1, B2) by using outgoing and incoming communication media (7, 4). The master station (A) includes a data transmission processor 1, a data reception processor 2, a receiving circuit 3, the incoming communication medium 4, a multiplexer 5, a transmission circuit 6, the outgoing communication medium 7, a delay measuring unit 8, a transmission timing calculator 9, a transmission permission signal generator 10, and a system controller 11. Communications are carried out with the slave stations (B1, B2) by using the outgoing communication medium 7, and delays (d1, d2) until the master station (A) are respectively measured. A transmission interval of signals for giving transmission permission to the slave stations is obtained. The signals for transmission permission are transmitted to the slave stations (B1, B2) based on the transmission interval.

### BACKGROUND OF THE INVENTION

1. Field of the Invention

The present invention relates to a communication method of a communication system designed to enable a plurality of communication devices to engage in communications of a time division multiple access type by a transmission medium (common communication medium may be used for incoming and outgoing communications). In this case, the communication system adjusts a transmission interval based on a delay between master and slave stations.

2. Description of the Related Art

A transmission system serves to efficiently and accurately transmit a signal (information) sent from a communication terminal to a terminal of an opposite side. A multiple system is used for realizing communications among a plurality of communication terminals by a signal communication medium.

Multiple system To enable a plurality of devices to perform communications with one another by sharing a single communication medium, capability of distinguishing a signal sent from a given device from a signal sent from another device and interpreting the signal must be provided.

An access system for the above purpose is generally called a multiple access system. The present invention is directed to a time division multiple access system among such systems.

Time division multiple access system The time division multiple access system enables signals sent from the plurality of devices to be distinguished from one another by varying transmission time from device to device.

In the time division multiple access system, the number of devices that transmit signals to the communication medium at a given point of time is always 1 or less, and control is executed to prevent collision of signals. Thus, a device that receives a signal from the communication medium can interpret all data from the other devices.

The time division multiple access system is generally classified into two types, i.e., a system for causing all the devices to control multiple access by one and the same procedure, mid a system for causing a given device to centrally control multiple access.

For convenience, the former is called an “autonomous” time division multiple access system, and the latter a “centralized control” time division multiple access system. Examples of the “autonomous” time division multiple access system are Ethernet, a token ring and the like.

“Centralized control” time division multiple access system Description is briefly made of G983.1 of ITU-T (abbreviated to G983.1, hereinafter) as a typical example of the “centralized control” time division multiple access system.

G983.1 is used for a communication system between a telecommunication carrier and subscribers, which uses a communication medium of an FTTH type. FIG. 1 shows its configuration. In G983.1, the communication system includes two types of devices, i.e., stations A and B, shown in FIG. 2.

Communications achieved by G983.1 are those of “1: many” between the station A and a group of the stations B. As shown in FIG. 2, the station A and the stations B are interconnected by incoming and outgoing communication media, and a signal transmitted from the station A reaches all the stations B through the outgoing communication medium.

Signals transmitted from all the stations B reach the station A through the incoming communication medium. For such incoming communications, the “centralized control” time division multiple access system is used.

Basic access control method In G983.1, the station A is in charge of centralized control of time division multiple access. A basic procedure is as follows.

(1) The station A sends a signal for permitting a specific station B to engage in incoming transmission through the outgoing communication medium. The signal defines a period, in which the station B can send an incoming signal.

(2) Upon having received a notice of the incoming transmission permission, the station B sends an incoming signal to the incoming communication medium within the defined transmission period.

Problem of delay time A problem in the time division multiple access system is a difference in signal transmission time (referred to as delay time, hereinafter) between the devices engaged in signal transmission/reception.

By referring to FIG. 1, the problem is described by way of example where a delay between the station A and the station B1 is different from a delay between the station A and the station B2 (FIG. 2).

It is assumed that a delay between the station A and the station B1 is longer than a delay between the station A and the station B2. The station A sends a transmission permission signal to the station B1 (S1). In response, the station B1 sends an incoming signal for a period of mp1 (S2). Then, the station A receives the response of the period mp1 from the station B1 for a period mq1 (=mp1) (S2).

Subsequently, the station A sends a transmission permission signal to the station B2 (S4). Upon reception, the station B2 sends a response signal to the station A for a period of mp2 (S5). The station A receives the response signal for a period of mq2 (=mp2) (S5). Then, the station A sends transmission permission signals to the other stations B (S7).

In the described example, a maximum value of incoming signal transmittable time of the station B1 is estimated as follows. A transmission period of the station A from transmission of a transmission permission signal addressed to the station B1 by the station A to transmission of a transmission permission signal addressed to the station B2 is T, a delay of an incoming signal from the transmission of the transmission permission signal to the station B1 by the station A to reception of a response from the station B1 is d1, and a delay of an incoming signal from the transmission of the transmission permission signal to the station B2 by the station A to reception of a response from the station B2 is d2. In this case, a maximum value mp of incoming signal transmittable time of the station B1 is represented by the following expression:

mp=T−d1+d2=T−(d1−d2)

Means for improving use efficiency of the communication medium by measuring values of d1 and d2 will be described later. It is assumed that specific values of d1 and d2 are not measured one by one. In this case, in order to obtain the mp, by using an estimated value dmax, beyond which no delays should occur, in place of d1, and an estimated value dmin, below which no delays should occur, in place of d2, the following expression for mp′ must be evaluated in place of mp:

mp′=T−(dmax−dmin)

Time used for incoming communication in the period T is the mp′. Accordingly, use efficiency η′ of the incoming communication medium in the period is represented by the following expression:

η′=mp′/T=1−(dmax−dmin)/T

In case a difference between dmax and dmin of a delay estimated in the system is large, for example, if a large difference is expected in lengths of the communication media between the stations A and B, a reduction occuis in use efficiency of the communication media. Thus, a delay must be measured to adjust a transmission timing for the station B. In G983.1, the following procedure is employed.

(a) The station A sends a signal k1 for measuring a delay to a specified station B.

(b) In immediate response to the signal k1 for measuring waiting time received from the station A, the station B sends an incoming signal k2 to the station A.

(c) The station A measures transmitting/receiving time of the signals (k1, k2) (=delay time).

(d) The station A sends a signal for permitting incoming transmission from the station B. The signal defines a period, in which the station B can send an incoming signal, and designates standby time from reception of the incoming transmission permission signal from the station A by the station B to a start of incoming transmission.

(e) Upon having received the signal, the station B sends the incoming signal after waiting for the designated time.

For example, it is assumed that as a result of delay adjustment, the station A instructs the station B1 to delay transmission by de1, and the station B2 by de2. In this case, use efficiency η″ of the incoming communication medium is represented by the following expression:

η″=1−{(d1+de1≡−(d2+de2)}/T

The station A attempted to improve the use efficiency of the incoming communication medium by specifying de1 and de2 in such a way as to set d1+de1 and d2+de2 to substantially equal values.

### SUMMARY OF THE INVENTION

However, in the foregoing system (G983.1), the station B as a slave station needs at least a function of receiving the signal k1 for measuring a delay from the station A, a function of delaying transmission of an incoming signal by designated time, and the like. Consequently, the station B becomes complex in configuration and expensive.

The station A as a master station must carry out both of (1) the transmission procedure for starting incoming transmission from the station B and (2) the transmitting/receiving procedure for measuring a delay. Consequently, the station A also becomes complex in configuration. Furthermore, the station B cannot carry out proper incoming transmission during the execution of the transmitting/receiving procedure for delay measurement. Consequently, a reduction occurs in the use efficiency of the incoming communication medium.

The present invention was made to solve the foregoing problems. According to the present invention, it is possible to simplify a configuration of a slave station, and obtain a master station of a communication system, which employs a communication method of a time division multiple access type capable of improving use efficiency of a communication medium.

According to a technical aspect of the present invention, in a communication system for performing one-to-multi peer communications between a master station and plurality of stations through outgoing and incoming communication media, the master station includes means for executing communications with the slave stations through the communication media, and measuring delay time of the communication between each slave station and the master station, means for obtaining a transmission interval of signals for giving transmission permission to the slave stations based on the delay, and means for sequentially transmitting the signals for giving the transmission permission through the outgoing communication medium to the slave stations in accordance with the transmission interval.

According to other technical aspects of the present invention, a communication method of a first station for performing communications with plurality of stations through at least one outgoing communication medium and at least one incoming communication medium, having steps of executing communications with the stations, and measuring delays of communications with the stations, obtaining a maximum difference of delays between the communications with the stations, subtracting the maximum difference of delays from a predetermined transmission interval to be evaluated as a transmission interval, and transmitting a signal for transmission permission to each station based on the transmission interval.

### BRIEF DESCRIPTION OF THE DRAWINGS

FIG. 1 is a configuration view of a conventional communication system of one-to-multi peer communication.

FIG. 2 is a sequence diagram illustrating a conventional transmission interval and delay adjustment.

FIG. 3 is a configuration view schematically showing a master station of a communication system according to an embodiment of the present invention.

FIG. 4 is a sequence diagram illustrating delay measurement according to the embodiment.

FIG. 5 is a sequence diagram after adjustment of a transmission interval according to the embodiment.

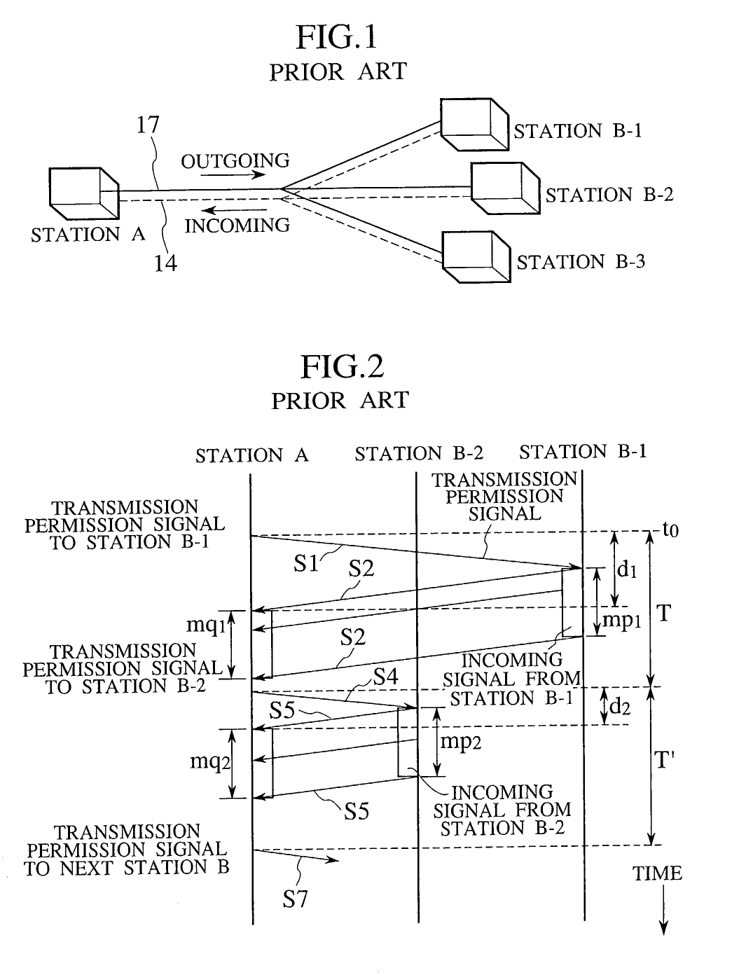

### DESCRIPTION OF THE PREFERRED EMBODIMENT

The present invention provides a “centralized control” time division multiple access system for performing one-to-multi peer communication, which is designed to improve use efficiency of a communication medium shared by a plurality of peers.

The improvement of the use efficiency of the communication medium in the time division multiple access system necessitates execution of control with consideration given to a difference, if any, in signal delays caused by a difference in lengths of communication media (optical fibers or the like) in signal transmission between a communication device (a station A as a master station) for controlling time division multiple access and a communication device (a station B as a slave station) to be controlled.

Conventionally, a transmission timing of the station A was fixed, and the station B was requested to adjust many delays. According to an embodiment of the present invention, however, all such processing operations are eliminated, thereby reducing functions to be provided in the station B. Therefore, the use efficiency of the communication medium can be improved.

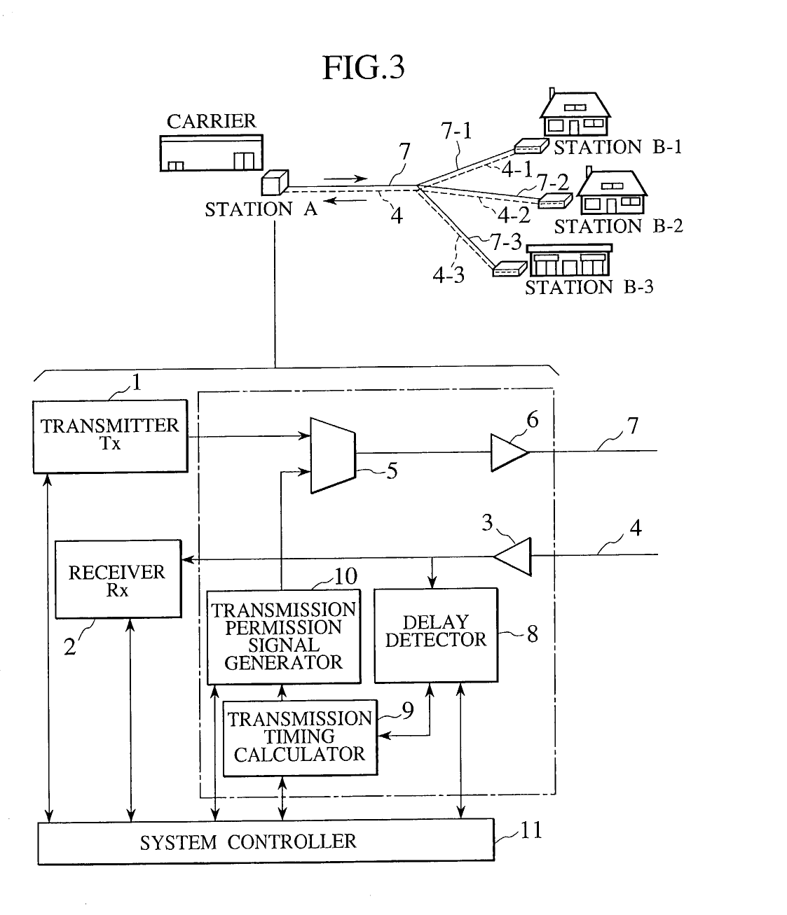

FIG. 3 is a configuration view schematically showing a master station of a communication system of the embodiment. The system of FIG. 3 has the following features: (1) one-to-multi peer communication is performed between a single station A and a plurality of stations B (B1, B2, and the like), (2) a signal transmitted from the station A can reach all the stations B, and (3) signals transmitted by all the stations B can reach the station A.

As the embodiment regards the communication method, no limitations other than the above (1) to (3) are placed on a physical configuration of a system, to which the communication method is applied. In the invention, terms “station A” and “station B” are used. However, no limitations are placed at all on physical configurations thereof. Each of the stations A and B may be one physical function unit of a given device, or a single device physically.

Communications from the station A to the station B are called “outgoing”, and communications from the station B to the station A “incoming”.

In FIG. 3, the method of the embodiment is employed for the station A as a master station of an access network for Internet connection using a passive optical network (PON). The PON is made of optical fibers generally branched radially. Time division multiple access is suited for realizing communications from a plurality of users to a station of a carrier by using the network of the invention. The optical fiber has a longer transmittable distance compared with other communication media, and a difference in delays between the user and the station of the carrier is generally larger. In Internet connection, all the communications are carried out by IP packets, and thus the optical fiber is more fitting to the time division multiple system.

As shown in FIG. 3, the station A as a master station includes a transmission permission signal generator 10 for composing a transmission permission message, and a transmission time calculator 9 for supplying a timing for starting the generation of a message to the transmission permission signal generator 10.

The transmission permission message sent from the station A contains a code for identifying which of the stations B the message is addressed to. The message indicates time (transmittable period) for permitting continued transmission when the station B having received the message sends a response signal.

In addition to a function of time division multiple access control of the invention, the station A includes a function of basically sending general data to the station B, and a data transmission processor/transmitter 1 for this purpose.

The station A sends the transmission permission message, and other general data to an outgoing communication medium 7. The station A includes a multiplexer 5 for multiplexing the general data from the data transmission processor 1 and the transmission permission message from the transmission permission signal generator 10, and a transmission circuit 6 for transmitting a multiplexed signal through an outgoing communication medium 7.

The station A receives a response signal through an incoming communication medium 4 from each station B. This response signal may contain general data sent from the station B to the station A.

The station A includes a receiving circuit 3 for receiving a signal through the incoming communication medium 4, a delay measuring unit (delay detector) 8 for measuring a delay from a received incoming response signal, and a data reception processor/receiver 2 for receiving general data contained in the received response signal.

The station A includes a system controller 11. The system controller 11 controls a linkage operation of the units provided at the station A.

When the station B has received the transmission permission message sent from the station A and the station B immediately (within a feasible fixed period) sends a response signal to the station A if a code contained in the message to identify station indicates the station B itself. This response signal also contains a code for identifying which of the stations B the response signal is sent from. At the station B, general data directed to the station A may be contained in the response signal. For a period in which the station B can send the response signal, an upper limit is a transmittable period contained in the transmission permission message from the station A, which triggered the response signal.

In the present embodiment, an operation requested of the station B is only a function of making a immediate response upon reception of the transmission permission message from the station A. Different from the case of the conventional art where many processing operations have been requested of the station B regarding delay adjustment as described in later, most of those operations are eliminated in the embodiment. Thus, the station B of the invention can be simplified much more compared with the conventional art.

Hereinafter, description is made of an operation of the centralized control time division multiple access system of the station A as the master station constructed in the above-described manner. In the embodiment, the time division multiple access system is employed in order to prevent collision of signals transmitted from the plurality of stations B to the station A.

First Embodiment (Measurement of Delay Time)

The present embodiment regards a method for deciding a transmission timing of a transmission permission message to be executed in a stage as shown in FIG. 3, where the station A has not finished delay measurement (to be described later) for each station B, for example immediately after a system start, and a method for measuring a delay. If a delay for each station B as been measured, the station A can adjust a transmission time of a transmission permission message to improve use efficiency of an incoming communication medium. This system will be described later with reference to a second embodiment.

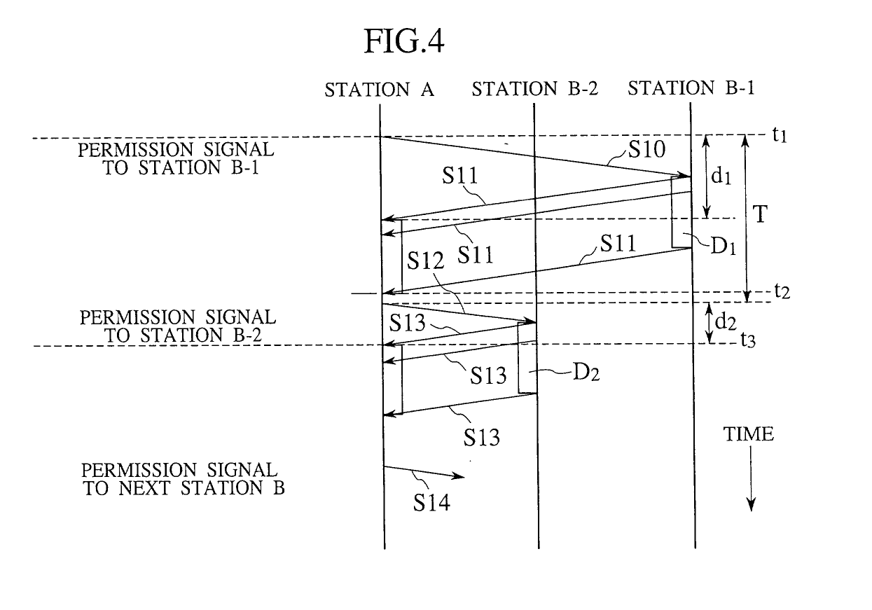

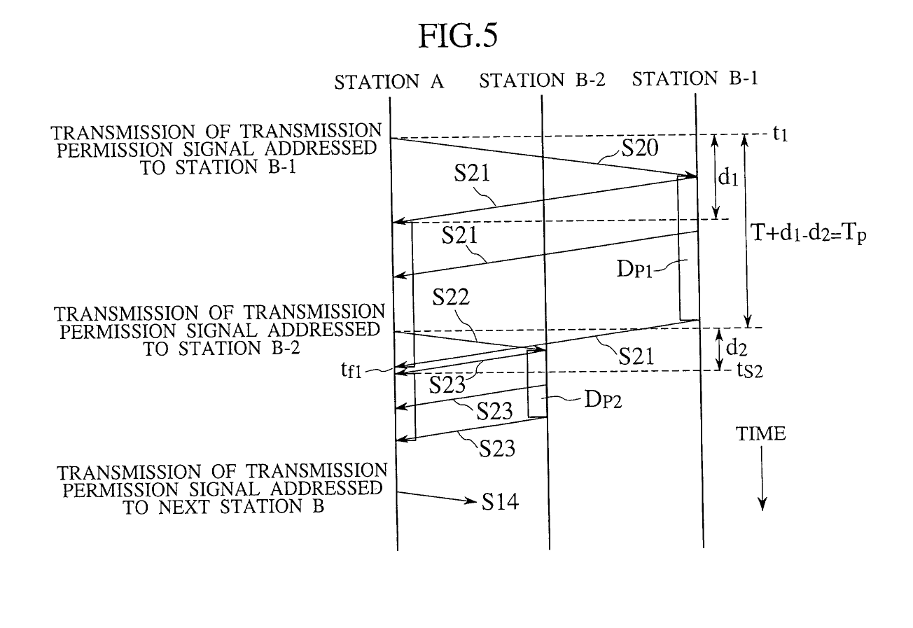

FIG. 4 shows a sequence of transmission of a transmission permission signal in a stage where the station A has not finished delay measurement for each station B, and corresponding response from the station B.

In FIG. 4, the station A first sends a transmission permission message S10 to the station B1, and then a transmission permission message S12 to the station B2. Thereafter, the station A sends a transmission permission message S14 to the other station B. A sequence after the transmission of S14 is similar, and thus only a sequence of transmission between the station A and the station B1, and between the station A and the station B2 is described.

In FIG. 4, an ordinate represents time, and an abscissa a distance. FIG. 4 shows an example where a distance from the station A to the station B1 is longer than that from the station A to the station B2.

The station A sends the transmission permission message S10 to the station B1 at time t1, and the transmission permission message S12 to the station B2 after the time t1 by a period of T.

In transmission of such a series of transmission permission messages to the stations B1 and B2, the station A controls a transmission timing of each transmission permission signal, and a transmittable period for permitting the station B to send an incoming response signal among the transmission permission signals, in order to prevent collision of response signals from the stations B1 and B2.

The system controller 11 of the station A sets an interval of transmitting the transmission permission messages to the stations B for the transmission timing calculator 9. In the example of the stations B1 and B2 of FIG. 3, the system controller 11 sends the transmission permission message for the station B1 to the transmission timing calculator 9, and then sets a period T until transmission of the transmission permission message to the station B2. For a transmittable period Tr for permitting the station B1 to send an incoming response signal lastly (after delay adjustment as described in the second embodiment), the period T is an upper limit in this case. Thus, for a request of designating a period for enabling the station B1 to send an incoming response signal (requested transmittable period), the period T may be set to a value equal to/higher than that of this period.

The timing calculator 9 counts an interval of transmission according to an instruction from the system controller 11, and instructs the transmission permission signal generator 10 to generate a transmission permission message when a timing for transmitting the transmission permission signal is reached. According to the embodiment, the transmission permission signal generator 10 is instructed to send a transmission permission message to the station B1 at the time t1, and generate a transmission permission signal for the station B2 of the other device after the period T.

The system controller 11 sets a value of a transmittable period to be contained in the transmission permission message to each station B for the transmission permission signal generator 10. This value is set to T−Δmax at the largest for the station B1 of FIGS. 3 and 4. The value Δmax herein represents an estimated maximum value of a difference in delay time from transmission of the transmission permission message to the station B by the station A to reception of a corresponding incoming response signal from the station B.

The Δmax can be easily estimated based on a physical configuration of the communication system. For example, if the station A is connected through optical fibers with the plurality of stations B, and the optical fibers for connecting these stations have lengths Lmax at the longest, and Lmin at the shortest, Δmax′ can be evaluated by adding variance in delays inside the station B to time of transmission of a signal through an optical fiber having a length of about (Lmax−Lmin)×2, i.e., to a round trip transmission delay of a maximum difference in lengths of the communication media.

In FIGS. 3 and 4, the transmission permission message generated by the transmission permission signal generator at the time t1 to be sent to the station B1 is passed through the multiplexer 5 and the transmission circuit 6, and sent to the outgoing communication medium 7 (S10 of FIG. 4).

Once the station B1 has received the S10, the station B immediately sends an incoming response signal because the transmission permission message is addressed to itself (S11).

Now, it is assumed that a return trip time for communications between the station A and the station B1 is as a delay d1 wherein the transmission permission message S10 is transmitted to the station B1 from the station A and to the response signal S11 from the station B1 is received by the station A from the station B1. A transmittable period indicated in the S10 is obtained as T−Δmax, and assuming that the incoming response signal from the station B1 by the station A has received at time t2. Then the time t2 is represented by the following expression at the latest:

t2=t1+d1+(T−Δmax)=t1+T+(d1−Δmax) (1).

On the other hand, assuming that a return trip time for communications between the station A and the station B2 as a delay d2 wherein the transmission permission message S12 to the station B2 is transmitted from the station A and an incoming response signal S13 is received from the station B2 by the station A. And assume that the reception of the incoming response signal from the station B2 by the station A is started at time t3, then the time t3 is represented by the following expression:

t3=t1+T+d2 (2).

Accordingly, an expression (2)-(1) is evaluated by the following expression with Δ12≡d1−d2:

Δt≡t3−t2=Δmax−Δ12 (3).

The expression (3) obviously takes a positive value. That is, no collision occurs in incoming signals from the stations B in accordance with the above expression.

The timing calculator 9 of the station A instructs the transmission permission signal generator 10 to generate a message when a timing for sending a transmission permission message to a station Bi (i=1, 2 . . . ) is reached. Simultaneously, the timing calculator 9 instructs the delay measuring unit (delay detector) 8 to start delay measurement for the station Bi.

Upon having received the instruction, the delay measuring unit 8 starts delay measurement for the station B-I from this point of time.

The incoming response signal from the station B is passed though the incoming communication medium 4 and the receiving circuit 3, and sent to the delay measuring unit 8. Upon reception of an incoming response signal from a given station B, the delay measuring unit 8 inspects a code contained in the incoming response signal to specify a station B, specifies the station Bi as a sender, and then stops delay measurement for the station B. Therefore, a value di as a delay is obtained for the station Bi.

In the example of FIG. 4, based on results of the transmission of the transmission permission message S10 to station B1 and the reception of the corresponding incoming response signal from the station B1, the delay measuring unit 8 measures a delay d1 of the station B1. Similarly, the delay measuring unit 8 measures a delay d2 of the station B2.

The delay measuring unit 8 notifies a measuring result of the delay di of each station Bi to the system controller 11.

Second Embodiment (Adjustment of Delay Time)

Description is made of a method for changing a transmission timing of a transmission permission message in order to efficiently use the incoming communication medium after a measuring result of a delay is obtained for each station B by the station A as described above.

FIG. 5 shows an example of a sequence where the station A that has obtained delay measuring results for the stations B1 and B2 changes a transmission timing of a transmission permission message, and notifies a longer transmittable period to the station B.

The system controller 11 of the station A obtains a delay measuring result for each station B from the delay measuring unit 8, and then changes a transmission interval of transmission permission messages to the stations B to be set in the transmission timing calculator 9 (delay adjustment).

In the examples of the stations B1 and B2 of FIGS. 4 and 5, the system controller 11 sets a period from the transmission of the transmission permission message to the station B1 to the transmission of the transmission permission message to the station B2 as T for the transmission timing calculator 9 before delay adjustment (FIG. 4) is performed.

Upon reception of a notice from the delay measuring unit 8 that delays for the stations B1 and B2 are respectively d1 and d2, then a period Tp, which is defined from the system controller 11 sends the transmission permission message to the station B1 until transmission of the transmission permission message to the next station B2 is completed, is changed in such as Tp=T+δ12 with δ12=d1−d2. The changed period Tp is set in the transmission timing calculator 9 (see FIG. 5). More generally, if a delay of the station Bi is di, and a delay of a station Bj is dj, then a period Tp between transmission of a transmission permission message to the station Bj and transmission of a transmission permission message to the station Bj is set as Tp=T+δij, wherein δij≡di−dj.

In changing of the transmission interval setting of the transmission permission messages, the system controller 11 of the station A can also change a transmittable period set in the transmission permission signal generator 10.

In the invention, time is not limited to real time. Any can be used as long as it can specify a quantity corresponding to time with the number of clocks, a phase difference or the like as a reference.

In the examples of the stations B1 and B2 of FIGS. 4 and 5, the system controller 11 sets the transmittable period contained in the transmission permission message to the station B1 as (T−Δmax) at the largest in the transmission permission signal generator 10 before delay adjustment (FIG. 4) is performed.

In changing of the transmission interval setting of the transmission permission messages (from T to Tp), the system controller 11 can change the transmittable period contained in the transmission permission message to the station B1 to T after delay adjustment (FIG. 5) is completed.

FIG. 5 shows a case where the system controller 11 of the station A sends the transmission permission message to the station B1, sets a period until the transmission permission message is sent to the station B2 as Tp (T+d12−d2), and changes the transmittable period for the station B1 to as T. In FIG. 4, the transmission permission message generated by the transmission permission signal generator at the time t1 to be sent to the station B1 is passed through the multiplexer 5 and the transmission circuit 6, and outputted through the outgoing communication medium 7 as represented by S20 of FIG. 5.

Upon having received the signal S20, the station B1 immediately sends an incoming response signal since the transmission permission message is addressed to itself (S21).

A delay from the transmission of the transmission permission message S20 addressed to the station B1 by the station A to the reception of the incoming response signal S21 from the station B1 has been measured to be d1. Since a transmittable period indicated in the message S20 is T, time t_{f1} at which the station A finishes the reception of the incoming response signal from the station B1 is expressed by the following at the latest:

t_{f1}=t1+d1+T (4).

On the other hand, a delay from transmission of a transmission permission message S22 addressed to the station B2 by the station A to reception of an incoming response signal S23 from the station B2 by the station A is as d2. Accordingly, time tₛ₂ at which the station A starts reception of the incoming response signal from the station B2 is represented by the following expression:

tₛ₂=t1+Tp+d2=t1+d1+T (5).

The expressions (4) and (5) take equal values (as the same time). That is, because of tf1≦tₛ₂, no collision occurs in incoming signals from the stations B even if delay adjustment is executed according to the embodiment.

Similarly, relations of the station A with the stations Bi and Bj can be estimated. Assuming that reception of an incoming response signal from the station Bi is finished at time t_{fi}, reception of an incoming response signal from the station Bj is started at subsequent time tₛⱼ, and then a relation of t_{fi}≦tₛⱼ is satisfied by setting as Tp=T+di−dj. Thus, no collision occurs in incoming signals from the stations B.

As described above, according to the present invention, in the one-to-multi peer communication system of the time division multiple access type for causing the master station to transmit a signal by using the outgoing communication medium, and thereby controlling the transmission timing from the slave station by using the incoming communication medium, a procedure for requesting the slave station can be limited to a very simple process. Thus, the slave station is simplified in configuration, making it possible to provide a slave station at a low price.

Moreover, the necessity of using a dedicated procedure for delay measurement is eliminated. Thus, much more time can be allocated to original incoming transmission, thereby improving use efficiency of the incoming communication medium.

This application claims benefit of priority under 35 USC §119 to Japanese Patent Applications No. 2001-238240, filed on Aug. 6, 2001, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A communication system for performing one-to-multi peer communications between a master station and plurality of slave stations by using outgoing and incoming communication media, wherein the master station includes
means for executing communications with the slave stations through the communication media, and measuring a delay of the communication between each slave station and the master station,
means for obtaining a transmission interval of signals for transmission permission to the slave stations based on the delay, and
means for sequentially transmitting the signals for the transmission permission via the outgoing communication medium to the slave stations in accordance with the transmission interval.

2. A communication system according to claim 1, wherein
the communication system evaluate a transmittable period of each slave station based on the delay in which transmission of data through the incoming communication medium by each slave station is permitted during the transmittable period.

3. A communication system according to claim 1, wherein a predetermined transmission period for obtaining the delay is combined with a difference in delays among the slave stations as the transmission interval for data transmission.

4. A first station for performing communications with plurality of stations including a second station and a third station through at least one outgoing communication medium and at least one incoming communication medium, comprising:
a delay measuring circuit for executing communications with the second station and the third station, and measuring communication delays thereof;
a circuit for evaluating a transmission interval of signals for transmission permission to the second station and the third station based on the delays of the second and third stations; and
a transmission circuit for transmitting the signals for transmission permission though the communication media to the second station and the third stations sequentially based on the transmission interval.

5. A communication system of a first station according to claim 4, wherein
the delay measuring circuit measures delays of communications with at least the second and third stations; and
the transmission interval evaluating subtracts a maximum difference value of delays of at least the second and third stations from a predetermined transmission interval to be evaluated as the transmission interval.

6. A communication system of a first station according to claim 4, wherein the transmission interval evaluating circuit subtracts the delay of the third station from the delay of the second station to be added to a predetermined transmission, and sets a result of the addition as a transmission interval of signals for transmission permission to the second and third stations.

7. A communication method of a first station for performing communications with plurality of stations through at least one outgoing communication medium and at least one incoming communication medium, comprising steps of:
executing communications with the stations, and measuring delays of communications with the stations;
obtaining a maximum difference of delays between the communications with the stations;
subtracting the maximum difference of delays from a predetermined transmission interval to be evaluated as a transmission interval; and
transmitting a signal for transmission permission to each station based on the transmission interval.

8. A communication method of a first station for performing communications with at least two stations including a second station and a third station through at least one outgoing communication medium and at least one incoming communication medium, comprising steps of:
executing communications with the second and third stations, and measuring a first and a second delays of the respective communications with the stations;
evaluating an interval of transmitting signals for transmission permission to the second station and the third station;
transmitting the signal for transmission permission to the second station; and
after passage of the interval of transmitting signals, transmitting the signal for transmission permission to the third station.
